(19) United States
(12) Patent Application Publication
(10) Pub. No.: US 2012/0170116 A1
(43) Pub. Date: Jul. 5, 2012

(54) ENHANCED IMAGE CONTRAST BETWEEN DIFFUSE AND SPECULARLY REFLECTING OBJECTS USING ACTIVE POLARIMETRIC IMAGING

(76) Inventor: Kristan P. Gurton, (US)

(21) Appl. No.: 12/983,910

(22) Filed: Jan. 4, 2011

(51) Int. Cl. G02B 5/30

(52) U.S. Cl. 359/485.01

(57) ABSTRACT

A polarization system having an active illumination source to produce polarized rays for irradiating a scene. The polarized illumination has a first predefined polarization state with at least one wavelength, a waveband detector to detect reflected rays from the scene, and a polarizing filter coupled to the waveband detector having a second predefined state which is selectively chosen according to the first predefined polarization state of the illumination source, and an enhanced image of the scene produced by said waveband detector.

### GOVERNMENT INTEREST

The presently disclosed subject matter was made with U.S. Government support by The Army Research Laboratory. Thus, The United States Government has certain rights in the disclosed subject matter. The embodiments described herein may be manufactured, used, and/or licensed by or for the United States Government without the payment of royalties thereon.

### BACKGROUND

The embodiments described herein generally relate to polarized electromagnet (EM) radiation. In particular, the embodiments relate to the state transformation of polarized EM radiation upon reflection, from a given surface, in a predictable manor from a given surface.

Generally, a polarized (either linear or circular) EM wave will undergo a change in polarization state upon being reflected from a surface and this change is dependent upon whether the surface is considered a specular or diffuse surface. Typically, if a surface is deemed smooth (i.e., individual, microscopic size facets that make up the surface are small as compared to the wavelength of light being reflected) the surface is considered specular. Conversely, a surface having uneven or granular characteristics (i.e., surface bumps or facets with dimensions large or comparable the wavelength) is typically considered diffuse. When polarized EM radiation is reflected from a specular surface, much of the original polarization state/information is retained. However, if the surface is diffuse, upon reflection, the initial state of polarization is reduced and in some cases may become completely depolarized. That is, the initial state of polarization retains no preferential polarization state. By taking advantage of this phenomena it has been determined that one can enhance image contrast between objects that are diffuse in nature from objects that are specular in nature, by artificially illuminating the scene with polarized EM radiation of an a priori determined state, and subsequently recording the reflected image forming “light” with a polarmetric imager or camera.

Currently, image/video based enhancement techniques to aid in the visual inspection and detection of small objects hidden within natural terrain and or vegetation, as outlined herein and discussed in further detail below, are scarce. As such, the current state-of-the-art technology is highly reliant on human cognitive recognition (i.e., looking with the unaided eye). Conversely, the present invention provides, among other things, an image/video based visual inspection technique that significantly improves the quality of resultant captured images by implementing active polarimetric based illumination and video capture techniques.

Discussed in further details below are examples of a general application of the embodiments herein outlining a typical application and device, utilizing a narrow region of the EM spectrum (i.e., near-IR wavelength in the range 0.8-2.0 μm). Note however, the description below merely contemplate a few examples of embodiments of the present invention, and as such, the present invention is not limited thereto. That is, there is no restriction or requirement for the region of the EM spectrum best suited for implementation since the fundamental principles outlined herein pertain to all wavelength regions of the spectrum. Further, it is to be noted that for a given application containing objects deemed specular and diffuse, the wavelength region chosen to illuminate a given scene should be of sufficient dimension so as to support the definition of “diffuse” and “specular,” as outlined above. For example, a given material may have surface anomalies/facets with dimensions on the order of 1 micron (i.e., 10 e-6 meters). If the active source for illumination is chosen, for example, to be in the ultraviolet wavelength (i.e., electromagnetic radiation with a wavelength shorter than that of visible light, but longer than x-rays, in the range 10 nm to 400 nm, and energies ranging from 3 eV to 124 eV), the reflecting surface would be considered diffuse. Conversely, if the same surface was illuminated with radiation in the long-wave infrared (LWIR) (electromagnetic radiation with a wavelength between 2.0 and 30 μm), the surface would exhibit specular reflection characteristics. Thus, the specific application/scene to be considered will generally dictate which portion of the EM spectrum is most appropriate.

### SUMMARY

In view of the foregoing, embodiments herein provide a polarization system including an active illumination source to produce polarized rays for irradiating a scene, the polarized illumination having a first predefined polarization state with at least one wavelength, a waveband detector to detect reflected rays from the scene, and a polarizing filter coupled to said waveband detector having a second predefined state selectively chosen according to said first predefined polarization state of said illumination source, an enhanced image of said scene produced by the waveband detector.

Additionally, a reflecting surface of the scene is determined by a wavelength of the polarized rays.

The polarized rays are composed of at least one quantity of light having a wavelength ranging between 10 nm and 400 nm, 400 nm and 700 nm, and 0.7 jam and 30 μm as well as greater than 700 nm

Further, the scene reflects a first group of polarized rays having a third polarization state associated therewith and an object located within the scene reflects a second group of polarized rays having a fourth polarization state associated therewith.

The first and second group of polarized rays are collected by the waveband detector and the polarizing filter blocks the second group of reflected light reflected from the scene to produce the image.

The illumination source may be a liner polarization source and accordingly, the waveband detector may be a linear detector. As such, the polarization state of the illumination source may be equal to the polarization state of the object.

Additionally, the illumination source may be a circular polarization source and accordingly, the polarization state of the illumination source is equal to the polarization state of the object and a helicity of the polarization state of the illumination source is opposite to a helicity of the polarization state of the object.

Moreover, the state of the polarizing filter is equivalent to the helicity of the polarization state of the object.

Additionally, the embodiments herein may include a method of polarization imaging including illuminating a scene via an active illumination source thereby producing a plurality of polarized rays, where the illumination source has a first predefined polarization state associated therewith, detecting reflected rays from the scene, filtering the reflected rays via a polarizing filter, the polarizing filter having a second predefined polarization state associated therewith, and capturing an image of said filtered reflected rays. The method may also include thresholding the image.

### BRIEF DESCRIPTION OF THE DRAWINGS

The embodiments herein will be better understood from the following detailed description with reference to the drawings, in which:

FIG. 1 illustrates a general configuration of the polariametric system of the present invention applicable for all EM spectrums according to an embodiment herein;

FIG. 2 illustrates the poliarmetric system with linearly polarized illumination having “like-state” filtering an illumination source according an embodiment herein;

FIG. 3 illustrates the polariametric system with circular polarized illumination with reversed helicity according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments described herein provide methods, tests and devices that include active polarimetric based illumination and video capture techniques.

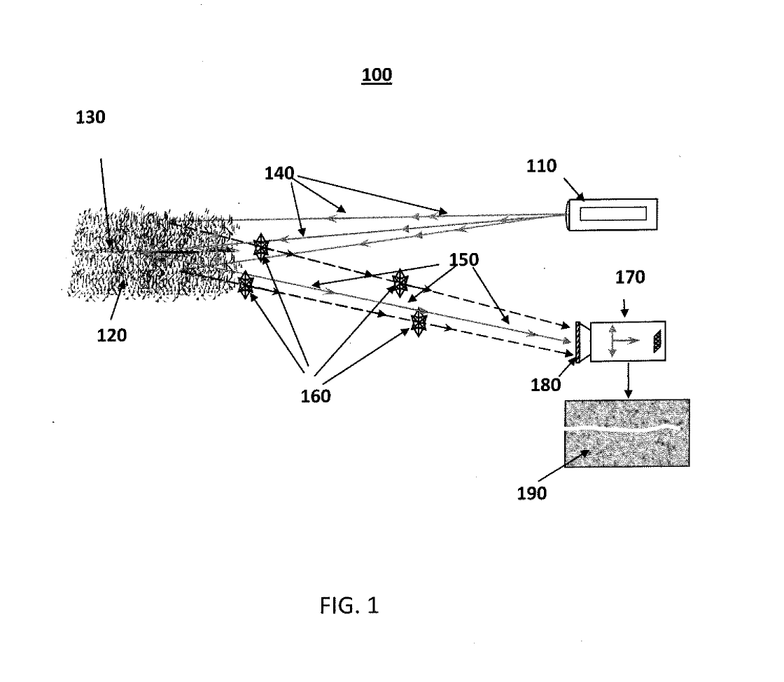

Referring now to the drawings, and more particularly to FIGS. 1 through 3, where similar reference characters denote corresponding features consistently throughout the figures, there are shown preferred embodiments of a polarimetric imaging system.

FIG. 1 is an illustration of a general configuration of the polarimetric system of the present invention applicable for all EM spectrums according to an embodiment herein.

Referring to FIG. 1, the polarimetric system 100 generally includes a waveband source illuminator 110 to produce polarized illumination, natural diffuse terrain background material or scene 120, a specular object 130, light rays signifying a particular state of polarization 140 generated by the waveband source illuminator 110, specularly reflected polarized light (denoted by the solid-line) 150 reflected from the specular object 130, diffusely reflected light with a reduced/randomized polarization state (denoted by the dashed-line) 160, a waveband detector 170 that is sensitive to the wavelength of the waveband source illuminator 110, an optical polarization filter 180 selected to pass only specularly reflected image forming light, and a resultant improved contrast image 190.

As shown in FIG. 1, a source of polarized illumination 110, having either a linear or circular polarization state, is projected onto a scene that consists of naturally occurring terrain 120, such as vegetation, grass, soil, or the like, that is optically diffuse for the particular wave-band region chosen for illumination. It is to be noted that the polarization source may include any suitable polarization source such as for example, a polarized laser or a broad-band lamp that has a polarizer affixed to the output.

The desired target for detection is a small, specular object 130 hidden within the scene 120. The specular object materials may include glass, metal, plastic, or ceramic materials, however, the embodiments herein are no not limited thereto.

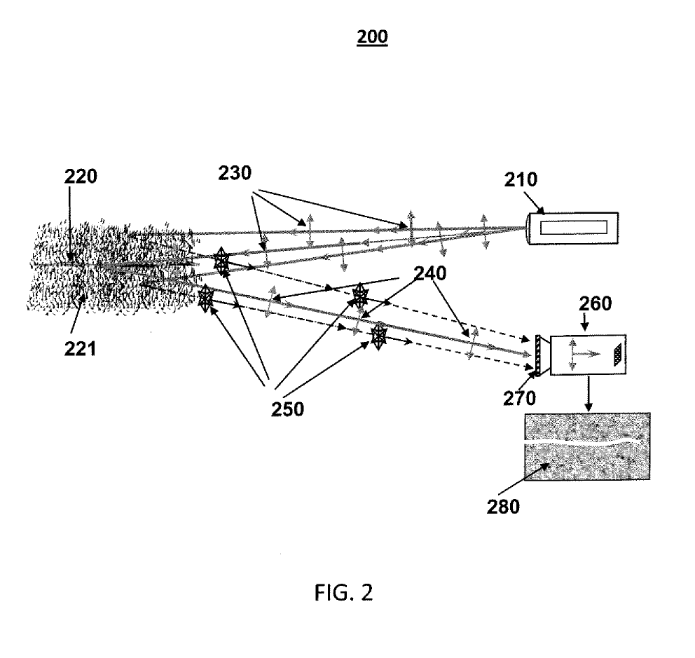

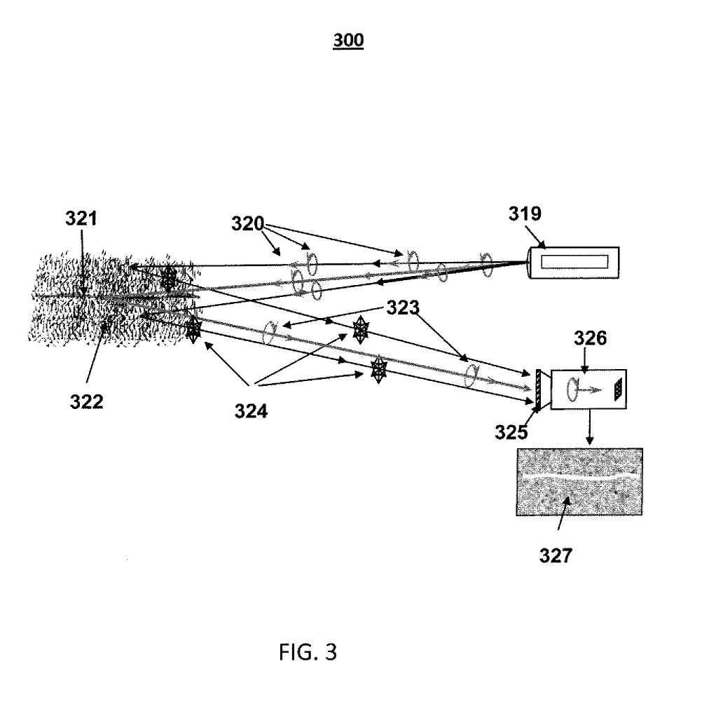

Polarized light rays 140 travel from the source 110 to the scene 120, thereby illuminating both the diffuse terrain background 120 as well as the specular object 130 hidden within the scene 120. The polarized light rays reflected from specular object 130 will possess an a priori known polarization state 150, which will be described in further detail below with reference to FIGS. 2-3. Conversely, diffusely reflected polarized light 160 illuminated from the diffuse background material will either be completely depolarized, or exhibit a significantly reduced degree of polarization as compared to the initial state of the original illuminating source 110. Both the strong or known polarized image forming light 150 reflected from specular object 130 and the greatly diminished (i.e., completely depolarized) light 160 reflected from the diffuse background 120, is collected by a waveband detector 170 in order to create an image/video of the scene. It is to be appreciated that the detectors well known in the art may be utilized and appropriate for response within the desired waveband of choice, e.g., such as a CCD camera appropriate for detection of visible and NIR radiation, however the present invention is not limited thereto.

Affixed to the input of waveband detector 170 is polarizing filter 180 having a state chosen based upon the application utilized and end user specifications, to enable the specularly reflected light 150 to enter the detector 170 and adequately block or filter out the diffusely reflected light 160 originating from the background 120. The final product is a resultant image 190 having an enhanced contrast such that the object of interest is predominately displayed in the image, while the complex background including noise and/or clutter originally making the specular object 130 hard to detect, is greatly reduced. It is to be noted that other parameters such as angle of incidence and material properties may have some effect with regard to the reflected light collected, but are inconsequential with regard to the embodiments disclosed herein and thus, are not discussed in detail.

It is to be appreciated that enhancement of the contrast image can be further improved via simple “thresholding” above or below a pixel intensity value or range. In particular, this can be done by the operator depending upon driving conditions. For instance, a thresholding adjustment, via an existing control on the waveband detector, would result in a simple binary type image in which the specular object 130 is distinctly displayed against a simple uniform background, i.e., thresholding or setting all pixel values less than or above a particular value to be displayed as a particular color or grayscale.

As discussed above, the polarimetric system 100 will utilize one of two possible polarization states, i.e., linear or circular polarization. As such, two approaches: 1) demonstrating linearly polarized illumination with “like-state” filtering at the illumination source 110 and 2) Circular polarized illumination with circular filtering at the illumination source 110, will be addressed in further detail below, with reference to FIGS. 2-3. However, it is to be appreciated that the embodiments herein are not limited to the examples outlined below and as such, various scenarios may be contemplated.

Linearly Polarized Illumination with “Like-State” Filtering at the Waveband Detector.

Shown in FIG. 2, is an illustration of linear polarimetric system with “like-state” filtering at the illumination source 210 according to another embodiment herein. Like-state is defined herein to mean having an identical state between source illumination and reflected light. Additionally, linear polarization is defined as a confinement of the electric field vector or magnetic field vector to a given plane along the direction of propagation Generally, the linear polarimetric system 200 includes a linear polarization source illuminator 210 (e.g., vertical), natural diffuse terrain background material or scene 221, a small, specular object 220, light rays signifying linearly polarization 230 generated by the source 210, specularly reflected linearly polarized light 240 from small object 220, diffusely reflected light 250 with an initial polarization state that is greatly reduced or eliminated (i.e., randomized), a waveband detector 260 sensitive to same wavelength region as source illuminator 210, a polarizing filter 270 chosen to solely pass a linearly polarized “like-state” image forming light, and a resultant improved contrast image 280.

Turning to FIG. 2, the projected light 230 is linearly polarized (i.e., parallel to the plane of the target or source) and similarly, the specularly reflected state 240 (i.e., the light reflected from object 130) is directly proportional to the projected light (i.e., is maintained). That is, if the illumination state of the projected light 230 is vertically polarized, the specularly reflected state 240 will also be vertically polarized and to that end, a vertical polarizer will be used to filter the waveband detector 270. Additionally, the same methodology would hold true if the initial illumination state is horizontally polarized, i.e., the reflected light from the specular object 130 would retain the horizontal polarization, and a horizontal polarizer would be used to filter the waveband detector 270. As discussed above with regards to the general configuration of the polarimetric system according to an embodiment herein, the diffusely reflected light 250 from the natural terrain 221 will possess a state that is greatly reduced or completely depolarized and will be partially filtered out by the polarized filter 270 mounted on the detector 260. The specularly reflected light 240 reflected from object 220 to be detected, is allowed to pass, and is collected by detector 260 in order to form an image. The final product is a contrast enhanced image 280 in which the object of interest is predominately displayed, while the complex background that originally made the object hard to detect, is greatly suppressed or alternatively, eliminated completely.

Circular Polarized Illumination with Reversed Helicity (i.e., Orthogonal State) Filtering at the Waveband Detector.

Shown in FIG. 3, is an illustration of circular polarimetric system 300 with reversed helicity circular filtering at waveband detector 326 according to another embodiment herein. Circular polarization is defined herein to mean polarization of an electromagnetic wave where the tip of the electric field vector, at a fixed point in space, describes a circle as time progresses The system 300 includes a circular (e.g., right-handed) source 319 of polarized illumination, natural diffuse terrain or complex background material 322, small specular object 321, light rays signifying right-handed circular polarization 320 generated by the source 319, specularly reflected polarized light 323 reflected from the small object 321, diffusely reflected light rays 324 having an initial circular polarization state that is greatly reduced or eliminated (i.e., randomized), waveband detector 326 sensitive to the same wavelength region as source illuminator 319, circular polarization filter 325 chosen to pass the reverse helicity state from that of the source illuminator 319 (for example purposes, the reverse helicity state is left-handed), and a resultant improved contrast image 327.

If the polarization state of the source illuminator 319 is circular in nature, the polarization state, upon reflection from a specular surface, was also found to be circular. However, the helicity (i.e., the projection of the spin onto the direction of propagation) for the same system was found to be reversed. For example, if the helicity of the polarization state of the source illuminator 319 is “right-handed” circularly polarized, the helicity of the polarization state reflected from the specular object 321 will be “left-handed” circularly polarized and thus, a left-handed” circular polarizer should be used to filter the waveband detector 326. Similarly, the converse is true and same methodology would hold true if the helicity of the polarization state of the source illuminator 319 is “left-handed circularly polarized. That is, light reflected from the specular object 330 would have a reverse helicity to that of the source illuminator 319 and be “right-handed” circular and, as such, a “right-handed” circular polarizer would be used to filter the camera.

Turning to FIG. 3, as with the general case discussed above with reference to FIG. 1, the diffusely reflected light 324 from the natural terrain 322 would possess a polarization state that is greatly reduced from the polarized state of the initial illumination 320, or be completely depolarized altogether and is partially filtered out by the polarizer filter 325 mounted on the waveband detector 326. The specular reflected light 323 from object 321 is allowed to pass, and is collected by the waveband detector 326 in order to form an image.

The final product is a contrast enhanced image 327 whereby the object of interest is predominately displayed, while the complex background 322 that originally made the object hard to detect, is greatly suppressed and/or eliminated completely.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A polarization system comprising:
an active illumination source to produce polarized rays for irradiating a scene, said polarized illumination having a first predefined polarization state with at least one wavelength;
a waveband detector to detect reflected rays from said scene; and
a polarizing filter coupled to said waveband detector having a second predefined state selectively chosen according to said first predefined polarization state of said illumination source; and
an enhanced image of said scene produced by said waveband detector.

2. The system of claim 1, wherein a reflecting surface of said scene is determined by a wavelength of said polarized rays.

3. The system of claim 2, wherein said polarized rays are composed of at least one quantity of light having a wavelength ranging between 10 nm and 400 nm.

4. The system of claim 2, wherein said polarized rays are composed of at least one quantity of light having a wavelength ranging between 400 nm and 700 nm.

5. The system of claim 2, wherein said polarized rays are composed of at least one quantity of light having a wavelength ranging between 0.7 μm and 30 μm.

6. The system of claim 2, wherein said polarized rays are composed of at least one quantity of light having a wavelength greater than 700 nm.

7. The system of claim 1, wherein said scene reflects a first group of polarized rays having a third polarization state associated therewith and an object located within said scene reflects a second group of polarized rays having a fourth polarization state associated therewith.

8. The system of claim 7, wherein said first and second group of polarized rays are collected by said waveband detector and said polarizing filter blocks the second group of reflected light reflected from said scene to produce said image.

9. The system of claim 8, wherein said illumination source is a liner polarization source and said waveband detector is a linear detector.

10. The system of claim 9, wherein said polarization state of said illumination source is equal to said polarization state of said object.

11. The system of claim 8, wherein said illumination source is a circular polarization source.

12. The system of claim 11, wherein said polarization state of said illumination source is equal to said polarization state of said object and a helicity of said polarization state of said illumination source is opposite to a helicity of said polarization state of said object.

13. The system of claim 12, wherein said sate of said polarizing filter is equivalent to the helicity of the polarization state of said object.

14. A method of polarization imaging comprising:
illuminating a scene via an active illumination source thereby producing a plurality of polarized rays, wherein said illumination source has a first predefined polarization state associated therewith;
detecting reflected rays from said scene;
filtering said reflected rays via a polarizing filter, said polarizing filter having a second predefined polarization state associated therewith; and
capturing an image of said filtered reflected rays.

15. The method of claim 14, further including thresholding said image.

16. The method of claim 14, wherein a reflecting surface of said scene is determined by a wavelength of said polarized rays.

17. The system of claim 16, wherein said polarized rays are composed of at least one quantity of light having a wavelength ranging between 10 nm and 400 nm.

18. The system of claim 17, wherein said polarized rays are composed of at least one quantity of light having a wavelength ranging between 400 nm and 700 nm.

19. The system of claim 17, wherein said polarized rays are composed of at least one quantity of light having a wavelength ranging between 0.7 μm and 30 μm.

20. The system of claim 17, wherein said polarized rays are composed of at least one quantity of light having a wavelength greater than 700 nm.

21. The system of claim 14, wherein said scene reflects a first group of polarized rays having a third polarization state associated therewith and an object located within said scene reflects a second group of polarized ray having a fourth polarization state associated therewith.

22. The system of claim 21, wherein said first and second group of polarized rays are collected by said waveband detector and said polarizing filter blocks the second group of polarized rays reflected from said scene to produce said image.

23. The system of claim 21, wherein said illumination source is a liner polarization source and said waveband detector is a linear detector.

24. The system of claim 23, wherein said polarization state of said polarized rays of said illumination source are equal to said polarization state of said polarized rays reflected from said object.

25. The system of claim 21, wherein said illumination source is a circular polarization source.

26. The system of claim 25, wherein said polarization state of said illumination source are equal to said polarization state of said object and a helicity of said polarization state is opposite to a helicity of said polarization state of said object.

27. The system of claim 26, wherein said sate of said polarizing filter is equivalent to the helicity of said polarization state of said object.
